(19) United States
(12) Patent Application Publication
(10) Pub. No.: US 2020/0173505 A1
(43) Pub. Date: Jun. 4, 2020

(54) BRAKE PAD FOR A DISK BRAKE SYSTEM AND DISK BRAKE SYSTEM

(71) Applicant: MANDO CORPORATION, Pyeongtaek-si (KR)

(72) Inventor: Felix BANDA, Pfaffenhofen (DE)

(21) Appl. No.: 16/694,110

(22) Filed: Nov. 25, 2019

(30) Foreign Application Priority Data
Dec. 3, 2018 (DE) 102018220863.8

(51) Int. Cl. F16D 65/095; F16D 55/226; B60T 1/06; F16D 65/00

(52) U.S. Cl. CPC F16D 65/095; F16D 55/2262; B60T 1/065; F16D 2055/0008; F16D 2200/0021; F16D 2200/0056; F16D 2250/0069; F16D 65/0056

(57) ABSTRACT

The invention relates to a brake pad for a disk brake system, comprising a backplate, the backplate being delimited by two opposing lateral surfaces and an edge comprising a leading edge and a trailing edge of the backplate, wherein a friction layer is attached to one of said lateral surfaces. The backplate comprises two hammerheads extending in a plane defined by the backplate, a leading hammerhead of the two hammerheads protruding from an outer end of the leading edge of the backplate and a trailing hammerhead of the two hammerheads protruding from an outer end of the trailing edge of the backplate.

### CROSS REFERENCE TO RELATED APPLICATION

This application claims priority under 35 U.S.C. § 119 to German Patent Application No. 102018220863.8, filed on Dec. 3, 2018 in the German Patent and Trade Mark Office (DPMA), the contents of which are herein incorporated by reference in their entirety

### TECHNICAL FIELD

The invention relates to a brake pad for a disk brake system. Furthermore, the invention relates to a disk brake system, in which a brake pad of the type envisioned here is used.

### BACKGROUND

State of the art disk brake systems comprise a number of parts which are movable with respect to each other and configured to abut against each other during braking. Abutting or touching movable parts are a main source of undesired braking noise. In particular, in common brake systems, when brake pressure is applied, the brake pads touch the brake disc and follow its movement until they abut against a stop which prevents a further movement. This impact leads to an abrupt deceleration to zero velocity of the brake pad. In some cases, depending on friction material and temperature, the brake pads impacting onto the stop can cause a clicking noise.

In the prior art, attempts have been made to address the issue of the clicking noise by modifying material properties of a friction material of the brake pad, which friction material contacts the brake disk during braking. However, the friction material should exhibit a high and fast rising initial friction level for better braking performance. Friction materials which are optimized for braking performance lead to a stronger acceleration of the brake pad, resulting in a higher impact force of the brake pad against the stop, in turn leading to a louder clicking noise.

### SUMMARY

There is thus a trade-off between reducing the clicking noise by modifying the friction material and having optimal braking performance.

It is an object of the present invention to reduce or eliminate the above-described clicking noise while achieving optimal braking performance.

This is achieved by a brake pad as defined by the features of independent claim 1. Furthermore, the object is achieved by a disk brake system with the features of claim 9. Advantageous embodiments are given by the dependent claims and by the description and the figures.

The brake pad envisioned here comprises a backplate which is delimited by two opposing lateral surfaces and an edge. Said edge comprises a leading edge and a trailing edge of the backplate.

A friction layer is attached to one of said lateral surfaces. The backplate further comprises two hammerheads extending in a plane defined by the backplate. A leading hammerhead of the two hammerheads protrudes from an outer end of the leading edge of the backplate and a trailing hammerhead of the two hammerheads protrudes from an outer end of the trailing edge of the backplate.

The edge of the backplate comprises a chamfer between an inner edge of the leading hammerhead and the leading edge, i.e., the chamfer represents a portion of the edge. The chamfer runs at a non-vanishing angle with respect to the inner edge of the leading hammerhead and with respect to the leading edge.

A clip having a U-shape is attached to the chamfer, the clip being formed of a strip consisting of a central portion and two end portions. The central portion forms a base of the U-shape and the two end portions form two opposite arms of the U-shape. The clip is arranged such that the central portion rests on the chamfer and the two end portions rest on the opposing lateral surfaces of the back-plate.

A brake pad of the above-described type can be used advantageously in a disk brake system for a vehicle. Such a disk brake system typically comprises two such brake pads.

Furthermore, a brake disk is provided, along with a caliper which holds the two brake pads on opposite sides of the brake disk. The brake pads are movably arranged and configured to be pressed against opposing surfaces of the brake disk for braking. A surface portion of the brake disk engaged with the brake pad moves with respect to the brake pad, from the leading side to the trailing side.

A leading edge stop and a trailing edge stop are provided at a distance from the brake disk. The brake pads are movably held by the caliper and arranged between the leading edge stop and the trailing edge stop, the leading edge being near the leading edge stop and the trailing edge near the trailing edge stop. This way, upon braking during a forward movement of the vehicle, the brake pads engage with the brake disk and are able to move along with the brake disk until the trailing edges of the brake pads abut against the trailing edge stop. Vice versa, upon braking during a backward movement of the vehicle, the brake pads engage with the brake disk and move along with the brake disk until the leading edges of the brake pads and the clips attached to the chamfers of the brake pads abut against the leading edge stop.

By providing the clip as described above, the movement of the brake pad or brake pads can be altered or limited as compared to brake pads without clips, leading to a reduction or even elimination of the clicking noise. On the one hand, the free play of the brake pad can be reduced. On the other hand, additionally or alternatively, the impact behaviour can be tuned depending on the materials used for the clip.

As pointed out, if the clip is provided at the chamfer, an impact involving a force acting on the clip occurs only during backward-braking, i.e. when braking during a backward movement of the vehicle. This has a number of advantages. For instance, the clicking noise is mostly perceived by users of the vehicle during backward-braking: Firstly, because the direction of movement has typically just been altered from a forward movement to a backward movement, such that the brake pads now have to be brought from one stop to the other. Secondly, backward braking usually occurs at lower speeds with less additional noise covering up the clicking noise. A further advantage is that having the impact onto the clip only for backward braking results in a lower wear on the clip, as backward-braking not only usually occurs at lower speeds than forward braking, but is typically also less frequent.

A width of the clip can be chosen to be smaller than or equal to a width of the chamfer. In those cases, the edge regions adjacent to the chamfer, i.e. the leading edge and the inner edge of the leading hammerhead remain uncovered.

This keeps the clip from being pushed out of place or being damaged by the stop. Also, residual drag caused by the clip can be avoided that way.

The strip forming the clip can for instance have a width of at least 2 mm and/or at most 7 mm. Furthermore, the strip can for instance have a thickness of between at least 0.5 mm and/or at most 3 mm.

The two end portions of the clip can have a length of at least 3 mm and/or at most 10 mm, to provide sufficient overlap with the lateral surfaces of the backplate for holding the clip in place.

The clip can for instance be glued to the backplate.

The clip can be made of metal and/or an elastomer. In particular, steel and rubber can be used for the clip. The clip can exhibit a layered structure, with two or more layers of different materials. In a possible embodiment, the clip comprises a rubber layer provided on an outer side of the clip and forming an outer surface of the clip. The elastomer, for example the rubber layer, can provide damping for the clicking noise. Additionally or alternatively, an inner side of the clip which is in contact with the backplate may be made of metal, such as steel, for example by having an inner layer of steel. The inner side may be adapted to enable gluing by choosing a suitable material, such as steel and/or a porous material, for the inner side of the clip.

In the brake pad envisioned here, the non-vanishing angle between the chamfer and the inner edge of the leading hammerhead can for instance lie between 30° and 60°.

In the disk brake system, the clip can be designed and arranged such that it is in contact with the leading knuckle finger in an off-braking condition. For instance, at least a leading portion or edge of the clip can be in contact with the leading edge stop. The clip can then smoothly slide along the leading edge stop during backward braking and can serve to hold the brake pad in place, against the trailing edge stop, in the off-braking condition.

The disk brake system, in particular when relating to a disk brake system for a front wheel of a vehicle, can comprise a knuckle. The knuckle typically holds the caliper and comprises a first knuckle finger forming the leading edge stop and a second knuckle finger forming the trailing edge stop.

Exemplary embodiments of the invention are shown in the figures attached hereto.

### BRIEF DESCRIPTION OF THE DRAWINGS

Therein

FIG. 1 shows an exploded view of a disk brake system,

FIG. 2 shows a detailed view of a portion of the brake system, exposing a brake pad abutting against a knuckle finger,

FIG. 3 shows a lateral view of the brake pad,

FIG. 4a shows a lateral view of a leading portion of a brake pad,

FIG. 4b shows the lateral view from FIG. 4a, with a clip attached to the brake pad,

FIG. 4c shows the brake pad as shown in FIG. 4b, the brake pad and the clip abutting against the knuckle finger,

FIG. 5a shows a front view of the clip, and

FIG. 5b shows a perspective view of the clip.

### DETAILED DESCRIPTIONS

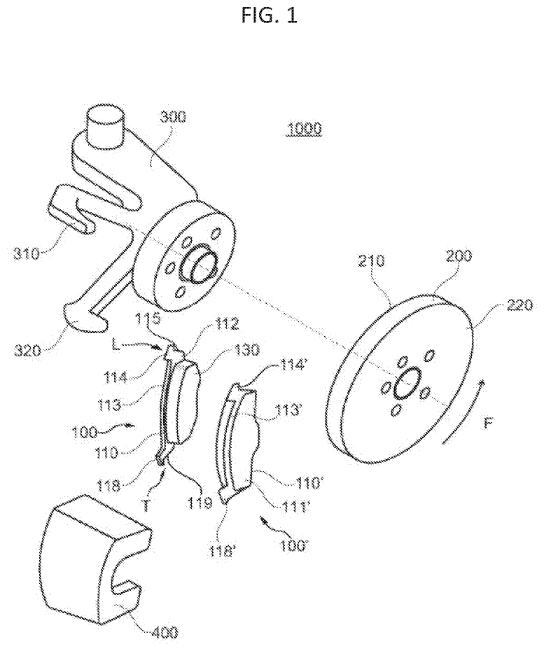

FIG. 1 shows an exploded view of a disk brake system 1000 for a vehicle. The disk brake system comprises a brake disk 200, a knuckle 300, a caliper 400 and two brake pads 100, 100′.

The two brake pads 100, 100′ exhibit essentially the same setup but are mirrored with respect to each other. To distinguish between the two brake pads, reference numerals pertaining to a second brake pad 100′ of the two brake pads 100, 100′ are hyphenated. All of the features discussed herein in the context of one of the brake pads 100, 100′ apply for both brake pads 100, 100′ unless stated otherwise.

The brake disk 200 is rotatably connected to the knuckle 300. A rotating direction of the brake disk 200 corresponding to a forward movement is illustrated in FIG. 1 by means of an arrow labelled with the letter F. The knuckle 300 comprises two knuckle fingers 310, 320, arranged at a substantially equal distance from the brake disk and extending orthogonally to a plane defined by the brake disk. The caliper 400 and the two brake pads 100, 100′ are arranged between the two knuckle fingers 310, 320. The caliper 400 holds the two brake pads 100, 100′ on opposite sides of the brake disk, the brake pads 100, 100′ being movably connected to the caliper 400 by means of a piston such that they can be pressed against opposing surfaces 210, 220 of the brake disk 200 for braking.

The brake pads 100, 100′ each comprise a backplate 110, 110′ which is in each case delimited by two opposing lateral surfaces 111, 111′, 112, 112′ and an edge 113, 113′. Friction layers 130, 130′ are in each case attached to one 112, 112′ of the surfaces 111, 111′, 112, 112′. When the brake pads 100, 100′ are pressed against the brake disk 200, their respective friction layers 130, 130′ engage with the brake disk 200. The physical properties of the friction layers 130, 130′ are tuned to optimize braking performance when the friction layers 130, 130′ engage with the brake disk 200.

In the setup as shown in FIG. 1, upon braking during a forward movement of the vehicle (the brake disk 300 rotating in the direction of the arrow F), a portion of the brake disk 200 entering in contact with the brake pads 100, 100′ engages at first with the uppermost section of the friction layers 130, 130′. Said portion of the brake disk 200 then slides along the friction layers 130, 130′, from top to bottom. Therefore, the upper side of the brake pads 100, 100′, as depicted in FIG. 1, is referred to as the leading side L and the lower side of the brake pads is referred to as the trailing side T. The terms “leading” and “trailing” are used herein to refer to the parts lying on a particular one of these sides.

As the brake pads 100, 100′ are movably arranged between the knuckle fingers 310, 320, upon engagement with the brake disk 200 during braking, they will be dragged along with the brake disk 200 until they abut against one of the knuckle fingers 310, 320. The knuckle fingers 310, 320 thus act as stops for the brake pads 100, 100′. When braking during the forward movement of the vehicle, a trailing edge 119, 119′ of the backplates 110, 110′ will abut against the bottom one of the knuckle fingers, referred to as the trailing knuckle finger 320. If the direction of movement of the vehicle and thus the rotating direction are altered and the brakes are applied anew, the brake pads 100, 100′ are dragged back up towards the upper knuckle finger, referred to as the leading knuckle finger 310. The leading knuckle finger 310 thus acts as a stop for a leading edge 115, 115′ of the backplates 110, 110′. In particular when applying the brakes for the first time after the rotating direction of the brake disk 200 has been altered, the brake pads 100, 100′ will move from one of the knuckle fingers to the other, resulting in an undesired clicking noise.

It is an object of the present invention to avoid such a clicking noise. It will be explained in the context of the following figures, how the clicking noise is advantageously avoided according to this application.

It should also be noted that the backplates 110, 110′ of the brake pads 100, 100′ comprise so-called hammerheads 114, 114′, 118, 118′. Corresponding to the previously introduced nomenclature, it is herein referred to leading hammerheads 114, 114′ and trailing hammerheads 118, 118′. The hammerheads 114, 114′, 118, 118′ form a part of the backplates 110, 110′ and protrude at outer ends of the leading and trailing edges of the backplates 110, 110′, respectively. The hammerheads 114, 114′ 118, 118′ ensure safe abutment of the edges 113, 113′ of the backplates 110, 110′ against the knuckle fingers 310, 320. The term “outer end” is defined with respect to the brake disk 200, i.e., is to be understood as radially outward.

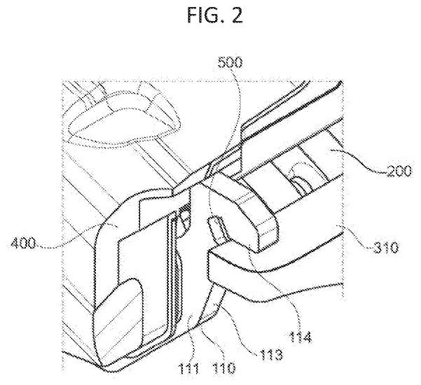

FIG. 2 shows an enlarged view of a section of the disk brake system from FIG. 1 in an assembled state. Therein, part of the caliper 400, part of the brake disk 200, and part of the leading side L of the brake pad 100 is shown. The leading hammerhead 114 can be seen, as it rests against the leading knuckle finger 310 representing the leading edge stop. This configuration is for instance typical during braking when the vehicle is moving in a backward direction. A U-shaped clip 500 is glued to the backplate 110 of the brake pad 100 near the leading hammerhead 114. The clip 500 extends over portions of the lateral surfaces 111, 112 of the backplate 110 and across the edge 113 of the backplate. The clip 500 also contacts the leading knuckle finger 310. The clip has an influence of the impact of the brake pad 100 onto the knuckle finger 310. It limits the movement of the brake pad 100 and has a surface made of a material that is softer than that of the leading edge, resulting in damping of the clicking noise.

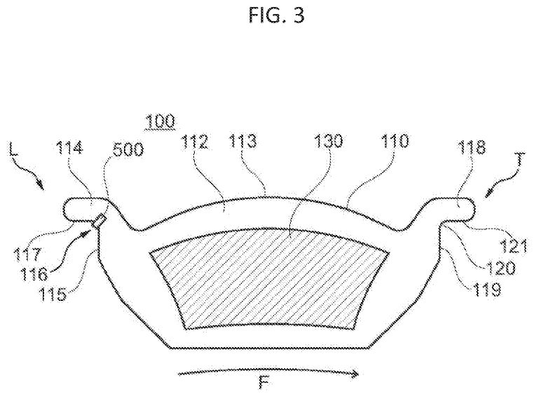

FIG. 3 shows the brake pad 100 from the previous figures in a side view in greater detail. The lateral surface 112 which holds the friction layer 130 is visible. An arrow labelled by the letter F indicates the rotating direction of the brake disk 200 for forward movement of the vehicle, allowing for the definition of the leading side L and the trailing side T of the brake pad 100.

The edge 113 runs about the entire backplate 110, including the leading hammerhead 114 and the trailing hammerhead 118. The edge of the backplate thereby runs substantially orthogonal to the planes defined by the lateral surfaces of the backplate. The edge 113 comprises the leading edge 115 and the trailing edge 119 of the backplate 110. The leading edge 115 and trailing edge 119 represent the areas predominantly subject to force upon impact of the brake pad 100 onto one of the stops 310, 320.

It can be seen from FIG. 3 that the two hammerheads 114, 118 extend in a plane defined by the backplate 110, the leading hammerhead 114 protruding from an outer end of the leading edge 115 of the backplate 110 and a trailing hammerhead 118 protruding from an outer end of the trailing edge 119 of the backplate 110, the outer ends once again being defined with respect to the brake disk 200.

The chamfer 116 is covered by the clip 500. The chamfer 116 lies between an inner edge 117 of the leading hammerhead 114 and the leading edge 115 of the backplate 100. At the chamfer 116, the edge 113 of the backplate 110 runs at a non-vanishing angle with respect to the inner edge 117 of the leading hammerhead 114 and with respect to the leading edge 115.

A trailing side of the brake pad 100 has a setup identical to that of the leading side, with a further chamfer 120 lying between the trailing edge 119 and an inner edge 121 of the trailing hammerhead 118. No clip is provided on the trailing side.

For both chamfers 116, 119, an angle with respect to the inner edge 117 of the leading hammerhead 114 lies between 30° and 60°, is in particular approximately 45°.

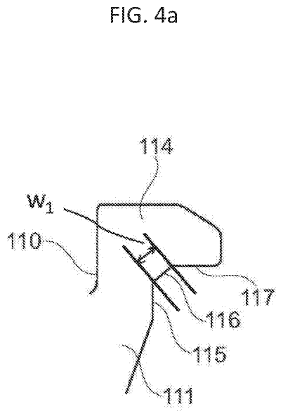

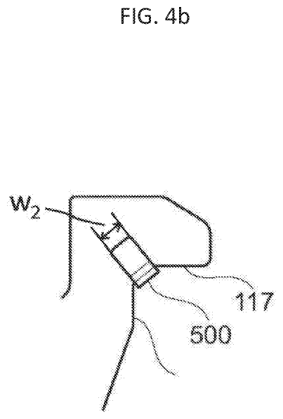

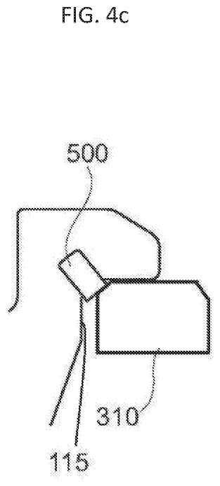

FIGS. 4 a to c show a side view of part of the leading side of the backplate 100. The opposite side from the view of FIG. 3 is shown.

In FIG. 4a, the leading side is shown before the clip 500 is attached thereto, exposing the chamfer 116 lying between the inner edge 117 of the leading hammerhead 118 and the leading edge 115. A width w₁ of the chamfer 116, extending between the inner edge 117 of the leading hammerhead 118 and the leading edge 115 is marked in FIG. 4a.

In FIG. 4b, the clip 500 is glued to the backplate 110 in the region of the chamfer 116, the clip 500 covering the chamfer 116. A width w₂ of the clip 500 is indicated in the Figure and is identical to or smaller than the width w₁ of the chamfer 116.

FIG. 4c shows the setup of FIG. 4b in a non-braking condition, wherein the leading edge 115 but part of the clip 500 remains in contact with the leading knuckle finger 310. When braking during a backward-movement of the vehicle, the leading edge 115 moves towards the knuckle finger 310 and finally abuts against the knuckle finger 310, wherein the clip 500 provides damping during the impact.

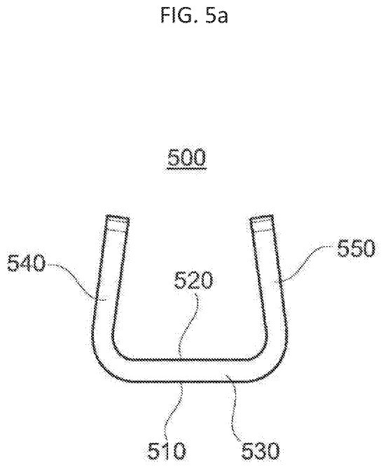

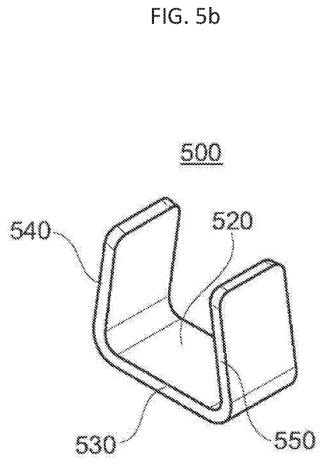

FIGS. 5 a and b show the clip 500, which dip 500 has already been discussed in the context of the previous figures. FIG. 5a displays the clip 500 in a side view and FIG. 5b in a perspective view.

The clip 500 is formed of a strip which has a U-shape. The strip consists of a central portion forming a base of the U-shape and two end portions 540, 550 forming two opposite arms of the U-shape. The central portion 530 is configured to rest on the chamfer 116 and the two end portions 540, 550 to rest on the opposing lateral surfaces 111, 112 of the backplate. A length of the central portion, i.e. a distance between the arms of the U-shape, is therefore chosen to be identical to a thickness of the backplate 100.

A width of the clip 500 is chosen to be approximately equal to the width of the chamfer 116, but not larger than the width of the chamfer 116.

The strip forming the clip 500 has a width of between 2 mm and 7 mm and a thickness of between 0.5 mm and 3 mm.

The two end portions 540, 550 have a length of between 3 mm and 10 mm.

The clip 500 comprises steel and rubber, steel being provided on an inner side 520 of the clip 500 to ensure sufficient stability and robustness of the clip 500 and provide a surface which can be glued to the backplate 110. A rubber layer is provided on an outer side 510 of the clip 500 and forms an outer surface of the clip. The rubber layer provides damping when the dip impacts onto the stop.

### LIST OF REFERENCE NUMERALS

1000 Disk brake system
100, 100′ Brake pad
110, 110′ Backplate
111, 112,
111′, 112′ Surfaces of the backplate
113, 113′ Edge of the backplate
114, 114′ Leading hammerhead
115, 115′ Leading edge
116, 116′ Chamfer
117, 117′ Inner edge of the leading hammerhead
118, 118′ Trailing hammerhead
119, 119′ Trailing edge
120, 120′ Further chamfer
121, 121′ Inner edge of the trailing hammerhead
130, 130′ Friction layer
200 Brake disk
210, 220 Opposing surfaces of the brake disk
300 Knuckle
310 Leading edge stop
320 Trailing edge stop
400 Caliper
500, 500′ Clip
510 Outer side of the clip
520 Inner side of the clip
530 Central portion of the clip
540, 550 End portions of the clip
F Rotating direction for forward movement
L Leading portion of the brake pad
T Trailing portion of the brake pad

What is claimed:

1. A brake pad for a disk brake system, comprising a backplate, the backplate being delimited by two opposing lateral surfaces and an edge comprising a leading edge and a trailing edge of the backplate, wherein a friction layer is attached to one of said lateral surfaces,
and wherein the backplate comprises two hammerheads extending in a plane defined by the backplate, a leading hammerhead of the two hammerheads protruding from an outer end of the leading edge of the backplate and a trailing hammerhead of the two hammerheads protruding from an outer end of the trailing edge of the backplate,
and wherein the edge of the backplate comprises a chamfer between an inner edge of the leading hammerhead and the leading edge, where the edge of the backplate runs at a non-vanishing angle with respect to the inner edge of the leading hammerhead and with respect to the leading edge,
characterized in that
a clip having a U-shape is attached to the chamfer, the clip being formed of a strip consisting of a central portion forming a base of the U-shape and two end portions forming two opposite arms of the U-shape, wherein the central portion rests on the chamfer and the two end portions rest on the opposing lateral surfaces of the backplate.

2. The brake pad of claim 1, wherein a width of the clip is smaller than or equal to a width of the chamfer.

3. The brake pad of claim 1, wherein the strip forming the clip has a width of between 2 mm and 10 mm and/or a thickness of between 0.5 mm and 3 mm.

4. The brake pad of claim 1, wherein the two end portions of the clip have a length of at least 3 mm and/or at most 10 mm.

5. The brake pad of claim 1, wherein the clip is made of materials comprising a metal and/or an elastomer.

6. The brake pad of claim 1, wherein the clip comprises a metal layer and an elastomer forming an outer surface of the clip.

7. The brake pad of claim 1, wherein the clip is glued to the backplate.

8. The brake pad of claim 1, wherein the non-vanishing angle between the chamfer and the inner edge of the leading hammerhead lies between 30° and 60″.

9. A disk brake system for a vehicle, comprising
two brake pads according to any of the preceding claims,
a brake disk with two opposing surfaces,
a caliper, movably holding the two brake pads on opposite sides of the brake disk, the brake pads being configured to be pressed against the opposing surfaces of the brake disk for braking,
a leading edge stop and a trailing edge stop provided at a distance from the brake disk,
wherein,
the brake pads are movably held between the leading edge stop and the trailing edge stop, such that, upon braking during a forward movement of the vehicle, the brake pads engaging with the brake disk move along with the brake disk until the trailing edges of the brake pads abut against the trailing edge stop, and, upon braking during a backward movement of the vehicle, the brake pads engaging with the brake disk move along with the brake disk until the leading edges of the brake pads and the clips attached to the chamfers of the brake pads abut against the leading edge stop.

10. A disk brake system according to claim 9, wherein the clip is in contact with the leading edge stop in a non-braking condition.

11. A disk brake system according to claim 9, comprising a knuckle which holds the caliper and comprises a first knuckle finger forming the leading edge stop and a second knuckle finger forming the trailing edge stop.
